(19) United States
(12) Patent Application Publication
(10) Pub. No.: US 2008/0145158 A1
(43) Pub. Date: Jun. 19, 2008

(54) Milling Cutter

(76) Inventors: Ching-Ching Chen, Wugu Township (TW); Ta-Chi Huang, Taipei City (TW)

Correspondence Address: HDSL, 4331 STEVENS BATTLE LANE, FAIRFAX, VA, 22033, US

(21) Appl. No.: 11/610,500

(22) Filed: Dec. 13, 2006

(51) Int. Cl. B23C 5/10

(52) U.S. Cl. 407/53

(57) ABSTRACT

A milling cutter is used for processing a metal substrate and includes a handle and a cutting portion. The cutting portion extends outward from one end of the handle. The cutting portion includes at least two opposite spiral guiding grooves. A cutting knifes is provided on one side of the guiding groove. The cutting knife has a spiral angle with range between 35°˜45° and the cutting portion is coated with a coating layer on surface thereof. The surface hardness, lubrication and scouring removing ability are enhanced. The abrasion and heat pipe for the cutting knifes 23 and 24 can be eliminated.

### BACKGROUND OF THE INVENTION

1. Field of the Invention

The present invention relates to a milling cutter, especially to a milling cutter for processing a metal substrate.

2. Description of Prior Art

The printed circuit boards (PCB) used for electronic products are generally made of plastic material or glass fiber. The PCB also uses metal substrate with aluminum and copper as the manufacture technology is improved and cost is reduced. For example, street lamp and headlamp generally uses PCB with substrate having enhanced strength and hardness. It becomes research issue to explore the relationship between metal substrate and milling cutter.

The conventional milling cutter, for example, Taiwan Utility Model No. M280878, comprises a handle and a cutting portion, where the cutting portion extends outward from one end of the handle. The cutting portion comprises two corresponding spiral guiding grooves. Cutting knife is formed on one side of the guiding groove. The spiral angle of the cutting knife is between 20°˜30°.

However, the conventional milling cutter can only be used for PCB with plastic or glass fiber substrate. The conventional milling cutter has small spiral angle such that the cutting knife has poor strength, large cutting resistance and poor scouring removing ability. The lifetime of milling cutter is reduced. Moreover, the surface hardness and lubrication of the conventional milling cutter are not enough because the surface of the conventional milling cutter is not coated with coating layer. Abrasion and heat pile may occur during the milling process of the milling cutter.

### SUMMARY OF THE INVENTION

The present invention is to provide a milling cutter with a cutting knife of specific spiral angle and at least one coating layer on surface thereof. The hardness, lubrication and scouring removing ability of the milling cutter are enhanced. The friction coefficient between knife and metal substrate, and heat pipe can be reduced to prolong the lifetime of the knife.

Accordingly, the present invention provides a milling cutter for processing a metal substrate. The milling cutter includes a handle and a cutting portion. The cutting portion extends outward from one end of the handle. The cutting portion includes at least two opposite spiral guiding grooves. A cutting knifes is provided on one side of the guiding groove. The cutting knife has a spiral angle with range between 35°˜45° and the cutting portion is coated with a coating layer on surface thereof.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows the front view of the present invention.

FIG. 2 shows the top view of the present invention.

FIG. 3 shows an enlarged view of portion A in FIG. 2.

FIG. 4 is a schematic view showing that the milling cutter of the present invention is applied to process metal substrate.

### DETAILED DESCRIPTION OF THE INVENTION

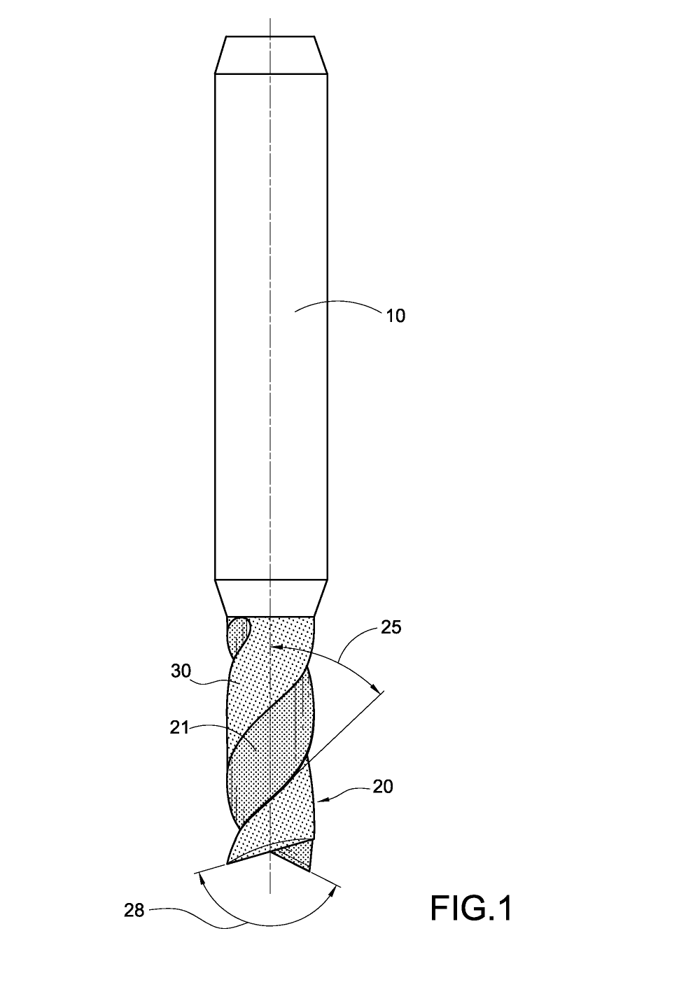

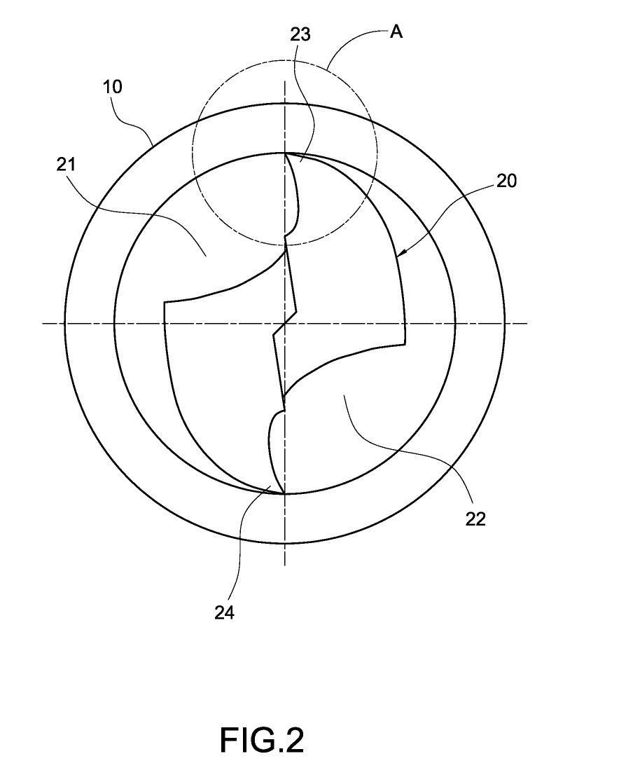

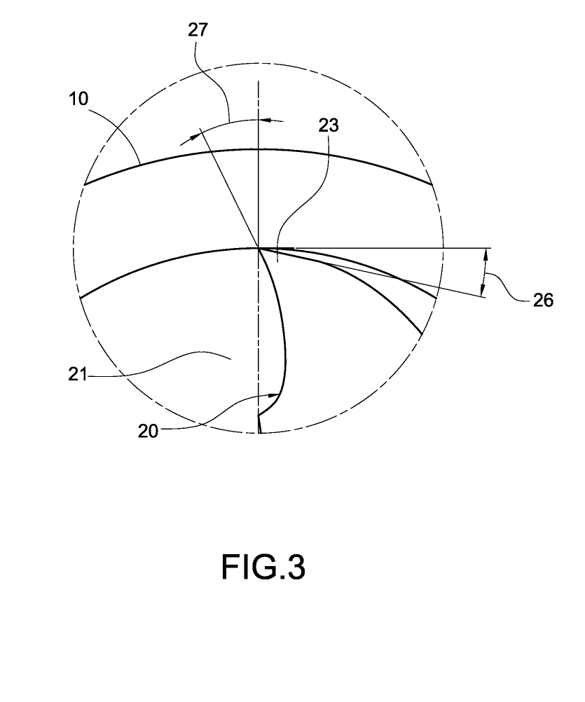

With reference to FIGS. 1 to 3, the milling cutter according to the present invention mainly comprises a handle 10 and a cutting portion 20. The handle 10 is a cylinder and the cutting portion 20 extends downward from bottom of the handle 10. In this preferred embodiment, the cutting portion 20 comprises two opposite spiral guiding grooves 21 and 22. The number of the spiral guiding grooves can also be three, four or more than four (not shown). Cutting knifes 23 and 24 are provided on one side of the spiral guiding grooves 21 and 22. A spiral angle 25 is defined between the tangent line of the cutting knifes 23 and 24 and an axial line; and the spiral angle 25 is in the range of 35°˜45°. The spiral angle 25 is preferably 40°. When the spiral angle 25 is larger than 45°, scouring is liable to accumulate and temperature will raise fast on the cutting knifes 23 and 24 when the milling cutter is used for processing. When the spiral angle 25 is smaller than 35°, the strength of the cutting knifes 23 and 24 is reduced and the lifetime of the cutting knifes 23 and 24 is also influenced.

The other two factors influencing the properties of the milling cutter are front gap angle 26 and a rear slant angle 27, where the front gap angle 26 is in the range 20°˜30° and the rear slant angle 27 is in the range 7°˜15°. Moreover, to facilitate the entering of the knife into the metal substrate 5, the inner angle 28 of the cutting knifes 23 and 24 is in the range 150°˜160° and the inner angle 28 of the cutting knifes 23 and 24 is preferably 154°.

Moreover, a coating layer 30 is coated on the surface of the cutting portion 20, where the coating layer 30 can be a nano coating layer and is coated on the surface of the cutting portion 20 by physical vapor deposition (PVD). The coating material can be Zr, Cr, Ti or other material of high hardness.

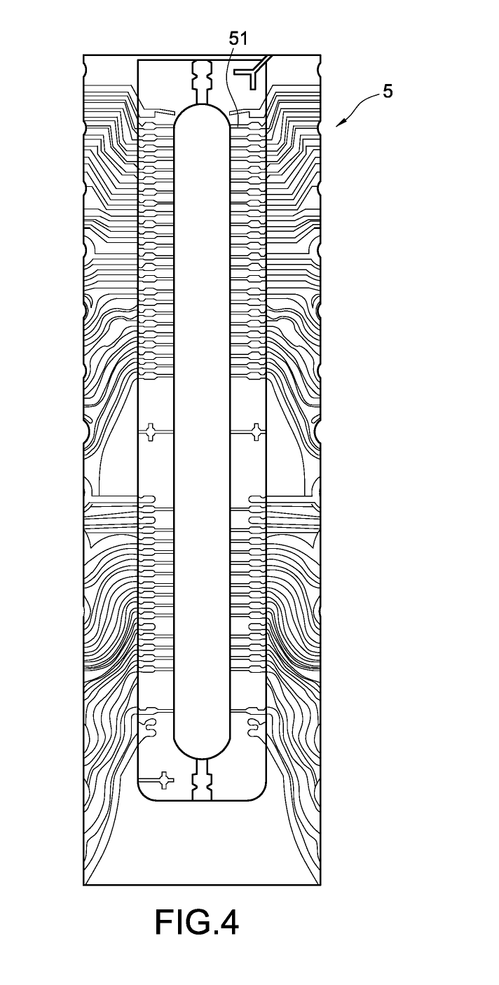

With reference to FIG. 4, the milling cutter according to the present invention is used for the processing of a metal substrate 5, where the metal substrate 5 can be aluminum substrate, copper substrate or alloy substrate, and has intensive circuits 51 thereon. During processing the handle 10 of the milling cutter is retained in a rotational clam (not shown) and the cutting portion 20 processes the metal substrate 5. At first, two wing-shaped knifes at front side of the cutting portion 20 cut a through hole on the metal substrate 5 and the cutting portion 20 has rotational and planar motion with respect to the metal substrate 5. The cutting knifes 23 and 24 cut an elongated slot on the metal substrate 5 and the ends of the circuits 51 are smooth and neat.

The milling cutter according to the present invention has following advantages. The cutting knifes 23 and 24 have high strength, low cutting resistance and good scouring removing ability because the spiral angle is in the range of 35°˜45°. Therefore, the lifetime of the milling cutter is enhanced. Moreover, the surface of the milling cutter is coated with a nano coating layer 30 to render it with high surface hardness and good lubrication. The abrasion and heat pipe for the cutting knifes 23 and 24 can be eliminated.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A milling cutter comprising:
A milling cutter comprising:
a handle; and
a cutting portion extended outward from one end of the handle, the cutting portion comprising at least two opposite spiral guiding grooves, cutting knifes provided on one side of the guiding grooves, the cutting knife having a spiral angle with range between 40°˜45°, the cutting portion having two wing-shaped knifes at a distal end thereof, and the cutting portion being coated with a coating layer on surface thereof.

2. The milling cutter as in claim 1, wherein the spiral angle of the cutting knife is 40°.

3. The milling cutter as in claim 1, wherein the cutting knife has an inner angle with the range between 150°˜160°.

4. The milling cutter as in claim 3, wherein the inner angle of the cutting knife is 154°.

5. The milling cutter as in claim 1, wherein the cutting knife has a front gap angle with the range between 20°˜30°.

6. The milling cutter as in claim 1, wherein the cutting knife has a rear slant angle with the range between 7°˜15°.

7. The milling cutter as in claim 1, wherein the coating layer is a nano coating layer.

8. The milling cutter as in claim 7, wherein the nano coating layer uses Zr material.

9. The milling cutter as in claim 7, wherein the nano coating layer uses Cr material.

10. The milling cutter as in claim 7, wherein the nano coating layer uses Ti material.
